(19) United States
(12) Patent Application Publication
(10) Pub. No.: US 2014/0075538 A1
(43) Pub. Date: Mar. 13, 2014

(54) IP SPOOFING DETECTION APPARATUS

(71) Applicant: KOREA INTERNET & SECURITY AGENCY, Seoul (KR)

(72) Inventors: Chae-Tae IM, Seoul (KR); Joo Hyung OH, Seoul (KR); Dong Wan KANG, Seoul (KR); Se Kwon KIM, Seoul (KR); Sung Ho KIM, Seoul (KR)

(73) Assignee: Korea Internet & Security Agency, Seoul (KR)

(21) Appl. No.: 13/676,300

(22) Filed: Nov. 14, 2012

(30) Foreign Application Priority Data
Sep. 10, 2012 (KR) 10-2012-0099900

(51) Int. Cl. H04L 29/06

(52) U.S. Cl. CPC H04L 63/02; H04L 63/0236
USPC 726/13; 726/11

(57) ABSTRACT

An IP spoofing detection apparatus is provided. The IP spoofing detection apparatus comprising, a tunnel information extracting unit which extracts a first TEID and a user equipment IP address from a payload of a first GTP packet, and an abnormal packet detecting unit which extracts a second TEID from a header of a second GTP packet, and extracts a source IP address from a payload of the second GTP packet, wherein the abnormal packet detecting unit detects the second GTP packet as an IP spoofing packet if the first TEID and the second TEID are equal to each other, and the user equipment IP address and the source IP address are different from each other.

### CROSS-REFERENCE TO RELATED APPLICATION

This application claims priority from Korean Patent Application No. 10-2012-0099900 filed on Sep. 10, 2012 in the Korean Intellectual Property Office, and all the benefits accruing therefrom under 35 U.S.C. 119, the contents of which in its entirety are herein incorporated by reference.

### BACKGROUND OF THE INVENTION

1. Field of the Invention

The present inventive concept relates to an IP spoofing detection apparatus.

2. Description of the Related Art

With explosion of smart phone users and increasing variety of mobile services, mobile networks such as wideband code division multiple access (WCDMA) and long term evolution (LTE) networks have been changed to an open type service structure from a closed type service structure.

GPRS Tunneling Protocol (GTP) is a protocol used inside the mobile network, and consists of GTP-C packets for signaling and GTP-U packets for data transmission. GTP has been designed for signaling and data transmission for data services of a user equipment, and UDP has been designed to be used as a transport layer protocol.

Therefore, in the case where GTP packets are transmitted illegally or maliciously from the user equipment, abnormal packets may be generated inside the mobile network. However, GTP has been designed without considering detection of the abnormal packets.

### SUMMARY

The present invention provides an IP spoofing detection apparatus which detects an IP spoofing packet among GTP packets.

The present invention also provides an IP spoofing detection apparatus which blocks transmission of the GTP packet detected as the IP spoofing packet.

The present invention also provides an IP spoofing detection apparatus which records identification information of a user equipment that has transmitted the GTP packet detected as the IP spoofing packet.

The objects of the present invention are not limited thereto, and the other objects of the present invention will be described in or be apparent from the following description of the embodiments.

According to an aspect of the present invention, there is provided an IP spoofing detection apparatus comprising, a tunnel information extracting unit which extracts a first TEID and a user equipment IP address from a payload of a first GTP packet, and an abnormal packet detecting unit which extracts a second TEID from a header of a second GTP packet, and extracts a source IP address from a payload of the second GTP packet, wherein the abnormal packet detecting unit detects the second GTP packet as an IP spoofing packet if the first TEID and the second TEID are equal to each other, and the user equipment IP address and the source IP address are different from each other.

According to another aspect of the present invention, there is provided an IP spoofing detection apparatus comprising, a call management information storage unit which records a first TEID and a user equipment IP address inserted into a payload of a first GTP packet, and an abnormal packet detecting unit which extracts a second TEID from a header of a second GTP packet, and extracts a source IP address from a payload of the second GTP packet, wherein the abnormal packet detecting unit detects the second GTP packet as an IP spoofing packet if the first TEID and the second TEID are equal to each other, and the user equipment IP address and the source IP address are different from each other.

According to another aspect of the present invention, there is provided an IP spoofing detection apparatus comprising, a tunnel information receiving unit which receives a first TEID and a user equipment IP address extracted from a payload of a first GTP packet, and an abnormal packet detecting unit which extracts a second TEID from a header of a second GTP packet, and extracts a source IP address from a payload of the second GTP packet, wherein the abnormal packet detecting unit detects the second GTP packet as an IP spoofing packet if the first TEID and the second TEID are equal to each other, and the user equipment IP address and the source IP address are different from each other.

According to another aspect of the present invention, there is provided an IP spoofing detection apparatus comprising, a packet information extracting unit which extracts a TEID from a header of a GTP packet and extracts a source IP address from a payload of the GTP packet, and an abnormal packet detecting unit which refers to a user equipment IP address corresponding to the TEID from tunnel information stored in advance, and detects the GTP packet as an IP spoofing packet if the source IP address and the user equipment IP address are different from each other, and a packet processing unit which drops the GTP packet if the GTP packet is detected as the IP spoofing packet.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram showing a configuration of the WCDMA network;

FIG. 2 is a schematic diagram showing a configuration of the LTE network;

FIG. 3 is a schematic diagram showing information which is inserted into the GTP-C packet and extracted therefrom;

FIG. 4 is a schematic diagram showing information which is inserted into the GTP-U packet and extracted therefrom;

FIG. 5 is a schematic block diagram showing a configuration of an IP spoofing detection apparatus in accordance with an embodiment of the present invention;

FIG. 6 is a schematic table for explaining a tunnel information table stored in a tunnel information storage unit;

FIG. 7 is a schematic flowchart for explaining a method for detecting an IP spoofing packet by an abnormal packet detecting unit of FIG. 5;

FIG. 8 is a schematic block diagram showing a configuration of an IP spoofing detection apparatus in accordance with another embodiment of the present invention;

FIG. 9 is a schematic diagram for explaining a data call setting and data transmission process in the WCDMA network;

FIG. 10 is a schematic diagram for explaining the information which is inserted into the GTP packet in the data call setting and data transmission process of FIG. 9;

FIG. 11 is a schematic diagram for explaining a data call setting and data transmission process in the LTE network;

FIG. 12 is a schematic diagram for explaining the information inserted into the GTP packet in the data call setting and data transmission process of FIG. 11;

FIG. 13 is a schematic block diagram showing a configuration of an IP spoofing detection apparatus in accordance with still another embodiment of the present invention; and

FIG. 14 is a schematic block diagram showing a configuration of an IP spoofing detection apparatus in accordance with still another embodiment of the present invention.

### DETAILED DESCRIPTION OF THE EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will filly convey the scope of the invention to those skilled in the art. The same reference numbers indicate the same components throughout the specification. In the attached figures, the thickness of layers and regions is exaggerated for clarity.

It will also be understood that when a layer is referred to as being “on” another layer or substrate, it can be directly on the other layer or substrate, or intervening layers may also be present. In contrast, when an element is referred to as being “directly on” another element, there are no intervening elements present.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

The present invention will be described with reference to perspective views, cross-sectional views, and/or plan views, in which preferred embodiments of the invention are shown. Thus, the profile of an exemplary view may be modified according to manufacturing techniques and/or allowances. That is, the embodiments of the invention are not intended to limit the scope of the present invention but cover all changes and modifications that can be caused due to a change in manufacturing process. Thus, regions shown in the drawings are illustrated in schematic form and the shapes of the regions are presented simply by way of illustration and not as a limitation.

Hereinafter, embodiments of the present invention will be described with reference to the accompanying drawings. GTP packets, which will be described below, may be classified into two types, i.e., GTP-C and GTP-U packets. In the case of the GTP-C packets, GTP version 1 is used in the WCDMA network, and GTP version 2 is used in the LTE network. The GTP-U packets are used in the same manner in the WCDMA network and the LTE network. Since a difference due to the version of the GTP-C packets does not affect the main points of the present invention, the GTP-C packets according to GTP version 1 and the GTP-C packets according to GTP version 2 are collectively referred to as GTP-C packets in the following description.

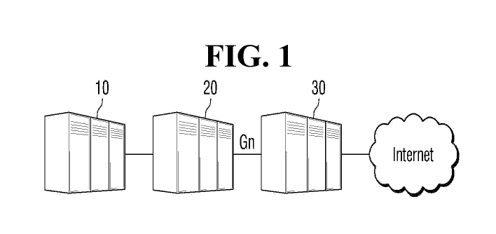

FIG. 1 is a schematic diagram showing a configuration of the WCDMA network. In the embodiment of the present invention, the wideband code division multiple access (WCDMA) network is explained as an example of a third-generation mobile network.

Referring to FIG. 1, the WCDMA network includes a radio network control (RNC) 10, a serving GPRS support node (SGSN) 20, a gateway GPRS support node (GGSN) 30 and the like.

In the WCDMA network, the GTP packets are transmitted and received as GTP-C and GTP-U packets on the Gn interface between the SGSN 20 and the GGSN 30.

Since a detailed description of each component of the WCDMA network might disturb the understanding of the main points of the present invention, the detailed description will be omitted.

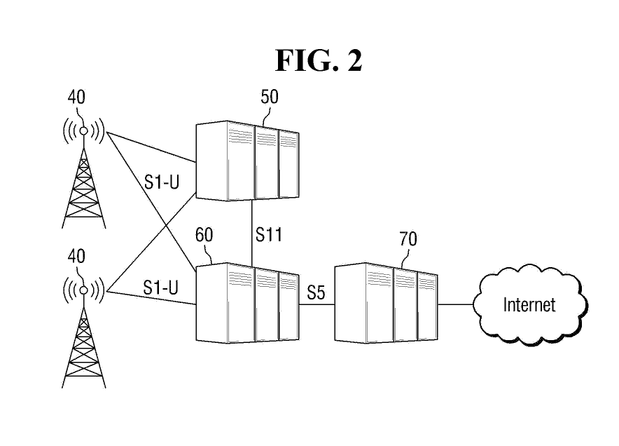

FIG. 2 is a schematic diagram showing a configuration of the LTE network. In the embodiment of the present invention, the long term evolution (LTE) network is explained as an example of a fourth-generation mobile network

Referring to FIG. 2, the LTE network includes an eNodeB (eNB) 40, a mobility management entity (MME) 50, serving gateway (S-GW) 60, a packet data network gateway (P-GW) 70 and the like. In this case, the S-GW 60 and the P-GW 70 may be separated from each other or configured integrally with each other as necessary.

In the LTE network, the GTP packets are transmitted and received as GTP-C packets on the S11 interface between the MME 50 and the S-GW 60, and transmitted and received as GTP-U packets on the S1-U interface between the eNB 40 and the S-GW 60. Further, the GTP packets may be transmitted and received as GTP-C and GTP-U packets on the S5 interface between the S-GW 60 and the P-GW 70.

Since a detailed description of each component of the LTE network might disturb the understanding of the main points of the present invention, the detailed description will be omitted.

The GTP-C packets are used to create, delete and update data calls between internal components (the SGSN 20 and the GGSN 30, the MME 50 and the S-GW 60, the S-GW 60 and the P-GW 70 and the like) of the mobile network such as WCDMA and LTE. In this case, data call setting is performed between the corresponding components when there is a request for data services from a user equipment (e.g., a smart phone).

The GTP-U packets are used to transmit and receive user data between internal components (the SGSN 20 and the GGSN 30, the eNB 40 and the S-GW 60, the S-GW 60 and the P-GW 70 and the like) of the mobile network such as WCDMA and LTE. The GTP-U packets include IP packets transmitted from the user equipment or external network.

Hereinafter, information which is inserted into the GTP packet and extracted by a packet information extracting unit 112 or the like will be described.

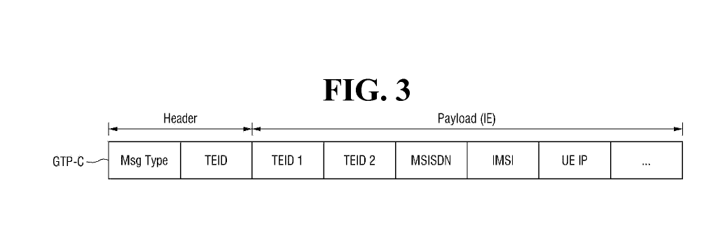

FIG. 3 is a schematic diagram showing information which is inserted into the GTP-C packet and extracted therefrom.

Referring to FIG. 3, a message type (Msg Type) and a tunnel endpoint identifier (TEID) may be inserted into a header of the GTP-C packet. Information elements (IEs) such as TEID which is allocated to the GTP packet to be transmitted subsequently, Mobile Station International ISDN (MSISDN) and International Mobile Subscriber Identity (IMSI) corresponding to identification information of the user equipment, and a user equipment IP address (UE IP; User Equipment IP) which is allocated to the user equipment may be inserted into a payload of the GTP-C packet.

The message type being inserted into the header of the GTP-C packet may include Create PDP Request (CP Req), Create PDP Response (CP Resp), Update PDP Request (UP Req), Update PDP Response (UP Resp), Delete PDP Request (DP Req), and Delete PDP Response (DP Resp) in the case of GTP version 1, and may include Create Session Request (CS Req), Create Session Response (CS Resp), Modify Bearer Request (MB Req), Modify Bearer Response (MB Resp), Create Bearer Request (CB Req), Create Bearer Response (CB Resp), Delete Session Request (DS Req), and Delete Session Response (DS Resp) in the case of GTP version 2.

The TEID (TEID 1, TEID 2) being inserted into the payload of the GTP-C packet may include TEID Ddata I and TEID Control Plane in the case of GTP version 1, and may include Fully qualified TEID (F-TEID) in the case of GTP version 2.

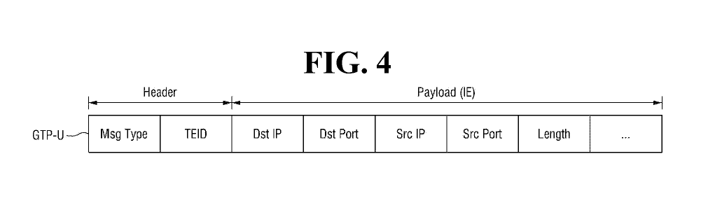

FIG. 4 is a schematic diagram showing information which is inserted into the GTP-U packet and extracted therefrom.

Referring to FIG. 4, a message type (Msg Type) and TEID may be inserted into a header of the GTP-U packet. Information elements (IEs) such as a destination IP address of the IP packet (Dst IP), a destination port (Dst Port), a source IP address (Src IP), a source port (Src Port), and a length of the packet (Length) may be inserted into a payload of the GTP-U packet.

The message type being inserted into the header of the GTP-U packet may include uplink data (UL-Data) indicating the GTP-U packet transmitted from the user equipment, and downlink data (DL-Data) indicating the GTP-U packet transmitted from the external network.

Hereinafter, a configuration of an IP spoofing detection apparatus and a method for detecting an IP spoofing packet in accordance with the embodiment of the present invention will be described.

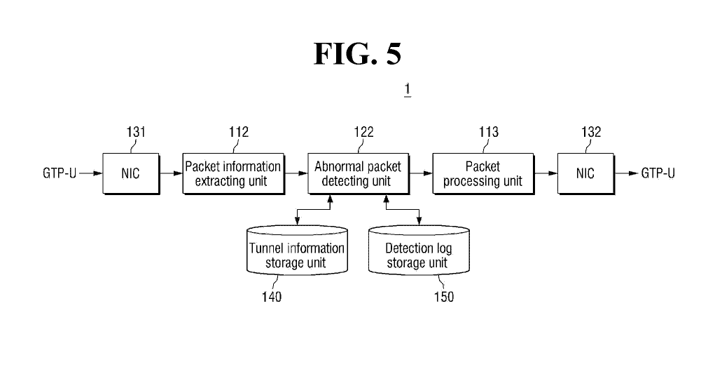

FIG. 5 is a schematic block diagram showing a configuration of an IP spoofing detection apparatus in accordance with an embodiment of the present invention.

Referring to FIG. 5, an IP spoofing detection apparatus 1 in accordance with the embodiment of the present invention includes the packet information extracting unit 112, an abnormal packet detecting unit 122, a tunnel information storage unit 140, a detection log storage unit 150, a packet processing unit 113 and NICs 131 and 132.

The packet information extracting unit 112 extracts various kinds of packet information from the GTP-U packet. The packet information extracting unit 112 extracts the message type (Msg Type) and the TEID from the header of the GTP-U packet, and extracts the destination IP address of the IP packet (Dst IP), the destination port (Dst Port), the source IP address (Src IP), the source port (Src Port), and the length of the packet (Length) from the payload of the GTP-U packet.

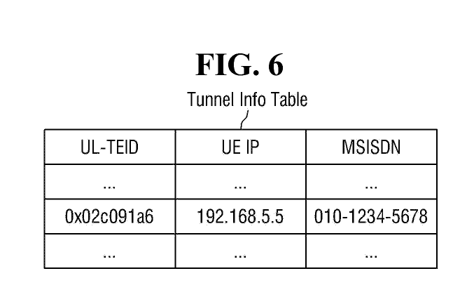

The abnormal packet detecting unit 122 detects whether the GTP-U packet is an IP spoofing packet based on the packet information of the GTP-U packet extracted by the packet information extracting unit 112. IP spoofing means a behavior of a sender of forging the source IP address to an IP address other than the allocated IP address and transmitting the forged IP packet. In the mobile network, IP spoofing represents that the source IP address of the packet transmitted from the user equipment is forged to an IP address other than the IP address allocated to the user equipment and the forged IP address is transmitted. A method for detecting the IP spoofing packet by the abnormal packet detecting unit 122 will be described later with reference to FIG. 6.

The packet processing unit 113 forwards or drops the GTP-U packet according to the detection result of the IP spoofing packet obtained by the abnormal packet detecting unit 122. In this case, forwarding means transmitting the GTP-U packet toward the destination of the mobile network, and dropping means blocking the GTP-U packet such that the GTP-U packet is not transmitted toward the destination of the mobile network.

The tunnel information storage unit 140 stores a tunnel information table (Tunnel Info Table) in which unique information of each GTP tunnel is recorded.

Referring to FIG. 6, the tunnel information table stores a UL-TEID, user equipment IP address (UE IP), and MSISDN for each GTP tunnel. In this case, the UL-TEID represents uplink TEID being inserted into the header of the GTP-U packet transmitted from the user equipment. For example, if the UL-TEID of the GTP-U packet transmitted through a specific GTP tunnel is “0x02c091a6,” the user equipment IP address (UE IP) corresponding to the UL-TEID is “192.168.5.5,” and the MSISDN is “010-1234-5678.”

If one GTP tunnel is created for each user equipment in the mobile network, the GTP-U packet transmitted through each GTP tunnel from the user equipment has its own UL-TEID. Further, each user equipment IP address (UE IP) is allocated to each user equipment, and each user equipment has a unique MSISDN.

In addition to the MSISDN, the IMSI may be stored as the identification information of the user equipment. In the embodiment of the present invention, although a case where one GTP tunnel is created for each user equipment is described for simplicity of description, the embodiment of the present invention is not limited thereto.

Referring again to FIG. 5, the detection log storage unit 150 stores the detection log according to the detection result of the IP spoofing packet obtained by the abnormal packet detecting unit 122. The detection log includes at least one of the MSISDN and IMSI as the identification information of the user equipment. The detection log may further include detection time, presence or absence of blocking, UL-TEID, destination IP address, destination port, source IP address, source port, length of the packet and the like.

The NICs 131 and 132 are configured to receive the GTP-U packet and transmit the GTP-U packet to the packet information extracting unit 112, and transmit the GTP-U packet according to a control signal of the packet processing unit 113. The NICs 131 and 132 may be general network interface cards or hardware-accelerated network interface cards.

In the IP spoofing detection apparatus 1 of FIG. 5, although the packet information extracting unit 112, the abnormal packet detecting unit 122, the packet processing unit 113, the tunnel information storage unit 140 and the detection log storage unit 150 have been described as separate components, it is obvious to those skilled in the art that the packet information extracting unit 112, the abnormal packet detecting unit 122, and the packet processing unit 113 may be formed integrally with each other, or the tunnel information storage unit 140 and the detection log storage unit 150 may be formed integrally with each other.

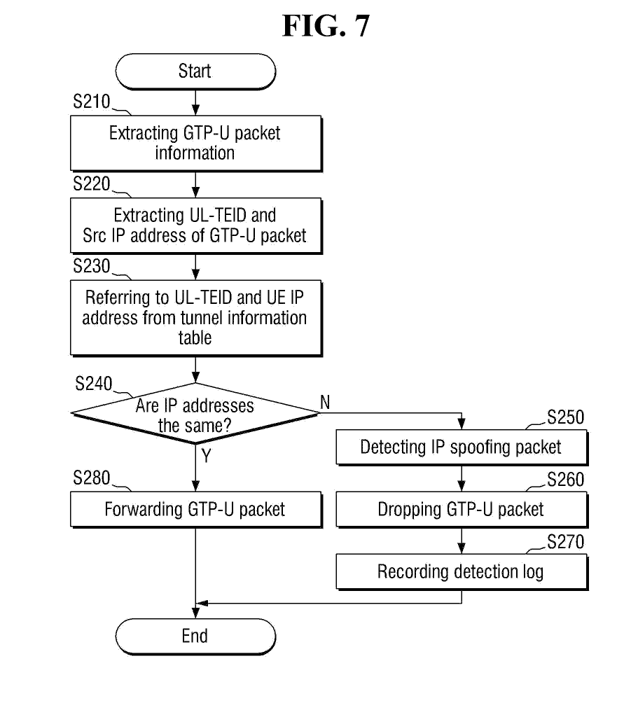

FIG. 7 is a schematic flowchart for explaining a method for detecting an IP spoofing packet by the abnormal packet detecting unit of FIG. 5.

Referring to FIG. 7, the packet information extracting unit 112 extracts various kinds of packet information from the GTP-U packet (step S210). Various kinds of packet information may include, as described above, the message type (Msg Type) and the TEID, which are extracted from the header of the GTP-U packet, and the destination IP address of the IP packet (Dst IP), the destination port (Dst Port), the source IP address (Src IP), the source port (Src Port), and the length of the packet (Length), which are extracted from the payload of the GTP-U packet.

Then, the abnormal packet detecting unit 122 extracts the UL-TEID and the source IP address from the packet information of the GTP-U packet (step S220). In this case, the UL-TEID represents the uplink TEID being inserted into the header of the GTP-U packet transmitted from the user equipment as described above.

Then, the abnormal packet detecting unit 122 refers to the UL-TEID and the user equipment IP address (UE IP) from the tunnel information table (step S230). More specifically, the abnormal packet detecting unit 122 refers to the user equipment IP address (UE IP) corresponding to the UL-TEID from the tunnel information table.

Then, the abnormal packet detecting unit 122 determines whether the source IP address (Src IP) extracted from the packet information of the GTP-U packet is equal to the user equipment IP address (UE IP) referred to from the tunnel information table (step S240).

Then, if the UL-TEIDs are equal to each other, but the source IP address and the user equipment IP address are different from each other, the abnormal packet detecting unit 122 detects the GTP-U packet as an IP spoofing packet (step S250).

Then, the packet processing unit 113 drops the GTP-U packet which has been detected as the IP spoofing packet (step S260).

Then, the abnormal packet detecting unit 122 records the detection log according to the detection result of the IP spoofing packet (step S270). As described above, the detection log includes at least one of the MSISDN and IMSI as the identification information of the user equipment.

Meanwhile, if the UL-TEIDs are equal to each other, but the source IP address and the user equipment IP address are equal to each other, the packet processing unit 113 forwards the GTP-U packet (step S280).

In the case of the normal GTP-U packet, the GTP-U packet transmitted through each GTP tunnel from the user equipment has the same source IP address. That is, the source IP address of the GTP-U packet should be equal to the user equipment IP address allocated to the user equipment. Thus, if the source IP address extracted from the GTP-U packet is different from the user equipment IP address referred to from the tunnel information table stored in advance, it can be detected that IP spoofing occurs.

In the method for detecting the IP spoofing packet by the abnormal packet detecting unit 122 of FIG. 7, although a case where the steps are sequentially performed has been described, the embodiment of the present invention is not limited thereto. For example, it is obvious to those skilled in the art that step S220 and step S230 of FIG. 7 may be performed in the opposite order or at the same time.

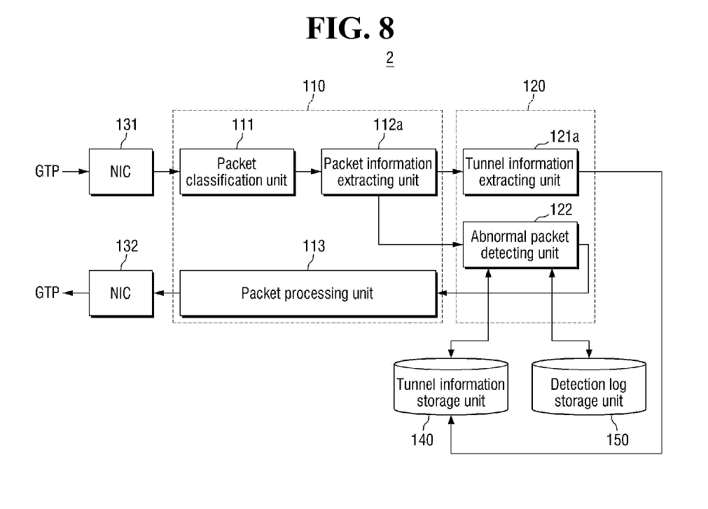

FIG. 8 is a schematic block diagram showing a configuration of an IP spoofing detection apparatus in accordance with another embodiment of the present invention. For simplicity of description, the description will be made focusing on differences from the IP spoofing detection apparatus 1 of FIG. 5.

Referring to FIG. 8, an IP spoofing detection apparatus 2 in accordance with another embodiment of the present invention includes a packet management module 110, a packet analyzing module 120, the tunnel information storage unit 140, the detection log storage unit 150, and the NICs 131 and 132.

The packet management module 110 includes a packet classification unit 111, a packet information extracting unit 112a, and the packet processing unit 113.

The packet classification unit 111 classifies the GTP packets. The packet classification unit 111 may classify the GTP packets into two types, i.e., GTP-C and GTP-U packets. The packet classification unit 111 may classify the GTP packets into GTP version 1 and GTP version 2 according to the version, or may classify the GTP packets according to the message type. The packet classification unit 111 may classify the GTP packets into Uplink Data packets which are transmitted from the user equipment and Downlink Data packets which are transmitted from the external network.

The packet information extracting unit 112a extracts various kinds of packet information from the GTP packets according to the classification result of the packet classification unit 111.

In the case of the GTP-C packet, the packet information extracting unit 112a extracts the message type (Msg Type) and the TEID from the header of the GTP-C packet, and extracts the TEID which is allocated to the GTP packet to be transmitted subsequently, the MSISDN, the IMSI, and the user equipment IP address (UE IP) from the payload of the GTP-C packet.

In the case of the GTP-U packet, the packet information extracting unit 112a extracts the message type (Msg Type) and the TEID from the header of the GTP-U packet, and extracts the destination IP address of the IP packet (Dst IP), the destination port (Dst Port), the source IP address (Src IP), the source port (Src Port), and the length of the packet (Length) from the payload of the GTP-U packet.

The packet analyzing module 120 includes a tunnel information extracting unit 121a, and the abnormal packet detecting unit 122.

The tunnel information extracting unit 121a extracts tunnel information based on the packet information of the GTP-C packet extracted by the packet information extracting unit 112a. The tunnel information includes the UL-TEID, the user equipment IP address (UE IP) and the MSISDN of each GTP tunnel. The tunnel information may include IMSI in addition to the MSISDN as the identification information of the user equipment. The tunnel information extracting unit 121a stores the extracted tunnel information in the tunnel information storage unit 140.

The tunnel information storage unit 140 stores the tunnel information table in which the unique information of each GTP tunnel is recorded. The tunnel information of each GTP tunnel extracted by the tunnel information extracting unit 121a is stored in the tunnel information table.

In the IP spoofing detection apparatus 2 of FIG. 8, although the packet management module 110 and the packet analyzing module 120 have been described as separate components, it is obvious to those skilled in the art that the packet management module 110 and the packet analyzing module 120 may be formed integrally with each other.

The IP spoofing detection apparatus 2 of FIG. 8 may be used to be disposed on the Gn interface between the SGSN 20 and the GGSN 30 where the GTP packets are transmitted and received in the WCDMA network. Further, the IP spoofing detection apparatus 2 of FIG. 8 may be used to be disposed on the S5 interface between the S-GW 60 and the P-GW 70 where the GTP packets are transmitted and received in the LTE network.

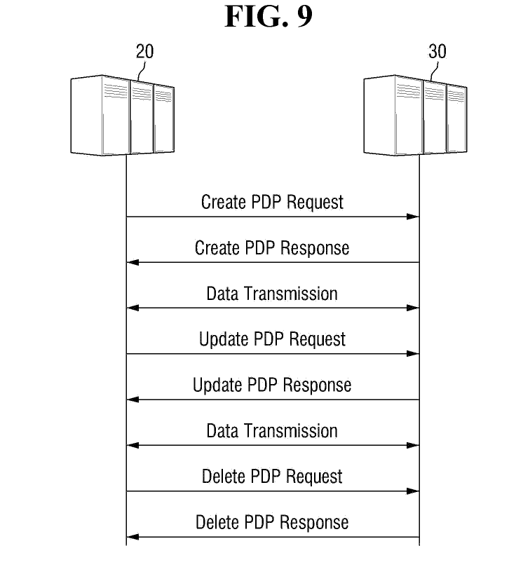

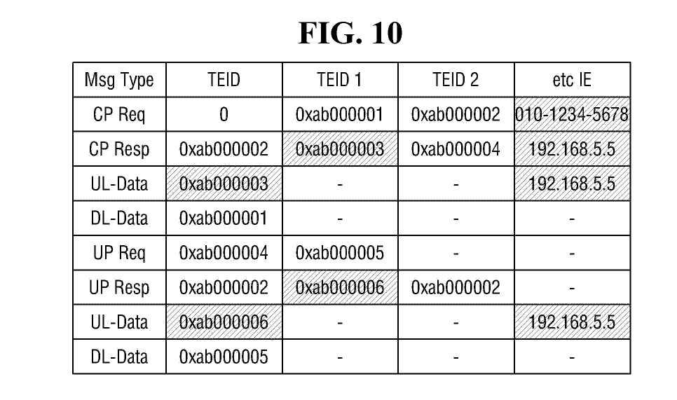

FIG. 9 is a schematic diagram for explaining a data call setting and data transmission process in the WCDMA network. FIG. 10 is a schematic diagram for explaining the information which is inserted into the GTP packet in the data call setting and data transmission process of FIG. 9.

Referring to FIG. 9, in the WCDMA network, the CP Req message and the CP Resp message are transmitted to create the GTP tunnel between the SGSN 20 and the GGSN 30.

Referring to FIG. 10, the MSISDN, e.g., “010-1234-5678” may be inserted into the payload of the CP Req message as the identification information of the user equipment. The packet information extracting unit 112a may extract the MSISDN from the payload of the CP Req message. In the case where the IMSI is inserted into the payload of the CP Req message, the packet information extracting unit 112a may extract the IMSI from the payload of the CP Req message in the same manner.

The UL-TEID, e.g., “0xab000003” which is allocated to the GTP packet to be transmitted subsequently from the user equipment may be inserted into the payload of the CP Resp message. The packet information extracting unit 112a may extract the UL-TEID from the payload of the CP Resp message. Further, the user equipment IP address, e.g., “192.168.5.5” allocated to the user equipment may be inserted into the payload of the CP Resp message. The packet information extracting unit 112a may extract the user equipment IP address from the payload of the CP Resp message.

The tunnel information storage unit 140 stores the UL-TEID and the user equipment IP address for each GTP tunnel based on the tunnel information extracted by the packet information extracting unit 112a.

Referring again to FIG. 9, the GTP tunnel is created and the GTP-U packet is transmitted between the SGSN 20 and the GGSN 30.

Referring to FIG. 10, the UL-TEID, e.g., “0xab000003” may be inserted into the header of the GTP-U packet of the UL-Data, and the packet information extracting unit 112a may extract the UL-TEID from the header of the GTP-U packet of the UL-Data. Further, the source IP address, e.g., “192.168.5.5” of the IP packet may be inserted into the payload of the GTP-U packet of the UL-Data, and the packet information extracting unit 112a may extract the source IP address from the payload of the GTP-U packet of the UL-Data.

The abnormal packet detecting unit 122 may refer to the user equipment IP address corresponding to the extracted UL-TEID, e.g., “0xab000003” from the tunnel information table, and detect the IP spoofing packet by comparing the source IP address with the user equipment IP address.

Referring again to FIG. 9, the UP Req message and the UP Resp message are transmitted to update the GTP tunnel between the SGSN 20 and the GGSN 30.

Referring to FIG. 10, as the GTP tunnel is updated, the updated UL-TEID, e.g., “0xab000006” which is allocated to the GTP packet to be transmitted subsequently from the user equipment may be inserted into the payload of the UP Resp message. The packet information extracting unit 112a may extract the updated UL-TEID from the payload of the UP Resp message. In this case, the TEID inserted into the header of the UP Resp message is equal to the TEID Control Plane, e.g., “0xab000002” inserted into the payload of the CP Req message.

Referring again to FIG. 9, the GTP tunnel is updated, and the GTP-U packet is transmitted between the SGSN 20 and the GGSN 30.

Referring to FIG. 10, the UL-TEID, e.g., “0xab000006” may be inserted into the header of the GTP-U packet of the UL-Data, and the packet information extracting unit 112a may extract the UL-TEID from the header of the GTP-U packet of the UL-Data. Further, the source IP address, e.g., “192.168.5.5” of the IP packet may be inserted into the payload of the GTP-U packet of the UL-Data, and the packet information extracting unit 112a may extract the source IP address from the payload of the GTP-U packet of the UL-Data.

The abnormal packet detecting unit 122 may refer to the user equipment IP address corresponding to the extracted UL-TEID, e.g., “0xab000006” from the tunnel information table, and detect the IP spoofing packet by comparing the source IP address with the user equipment IP address.

Since a detailed description of the data call setting and data transmission process in the WCDMA network might disturb the understanding of the main points of the present invention, the detailed description will be omitted.

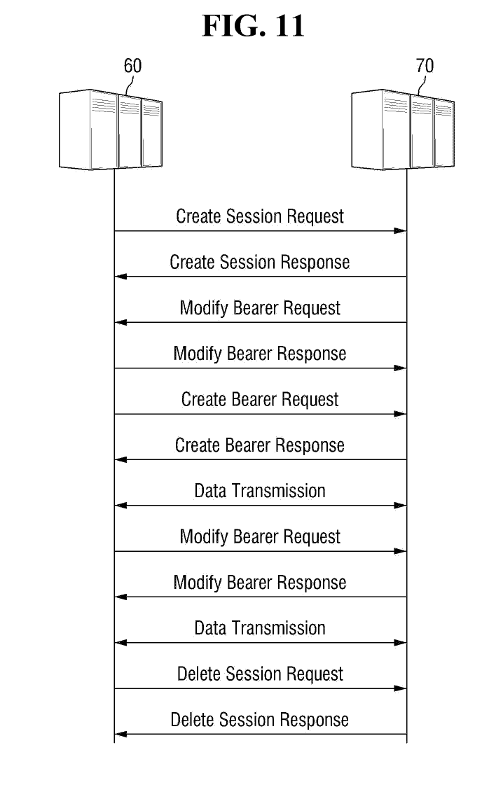

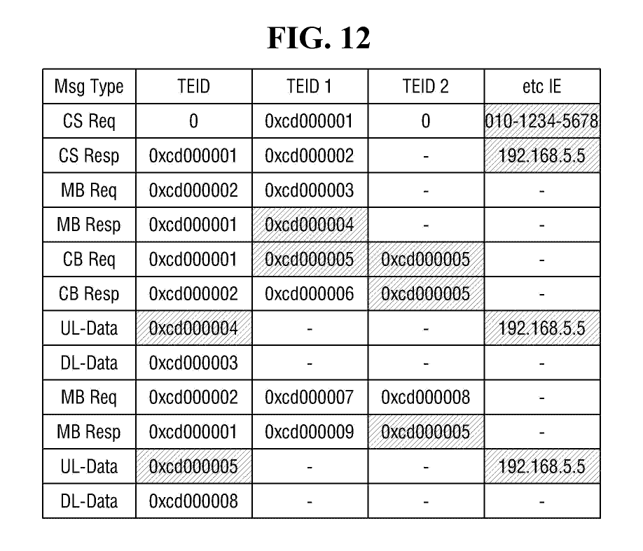

FIG. 11 is a schematic diagram for explaining a data call setting and data transmission process in the LTE network. FIG. 12 is a schematic diagram for explaining the information inserted into the GTP packet in the data call setting and data transmission process of FIG. 11.

Referring to FIG. 11, in the LTE network, the CS Req message and the CS Resp message, the MB Req message, the MB Resp message, the CB Req message, and the CB Resp message are transmitted to create the GTP tunnel between the S-GW 60 and the P-GW 70.

Referring to FIG. 12, the MSISDN, e.g., “010-1234-5678” may be inserted into the payload of the CS Req message as the identification information of the user equipment, and the packet information extracting unit 112a may extract the MSISDN from the payload of the CS Req message. In the case where the IMSI is inserted into the payload of the CS Req message, the packet information extracting unit 112a may extract the IMSI from the payload of the CS Req message in the same manner.

The user equipment IP address, e.g., “192.168.5.5” which is allocated to the user equipment may be inserted into the payload of the CS Resp message. The packet information extracting unit 112a may extract the user equipment IP address from the payload of the CS Resp message.

The UL-TEID, e.g., “0xab000003” which is allocated to the GTP packet to be transmitted subsequently from the user equipment may be inserted into the payload of the MB Resp message. The packet information extracting unit 112a may extract the UL-TEID from the payload of the MB Resp message.

The tunnel information storage unit 140 stores the UL-TEID and the user equipment IP address for each GTP tunnel based on the tunnel information extracted by the packet information extracting unit 112a.

Referring again to FIG. 11, the GTP tunnel is created and the GTP-U packet is transmitted between the S-GW 60 and the P-GW 70.

Referring to FIG. 12, the UL-TEID, e.g., “0xcd000004” may be inserted into the header of the GTP-U packet of the UL-Data, and the packet information extracting unit 112a may extract the UL-TEID from the header of the GTP-U packet of the UL-Data. Further, the source IP address, e.g., “192.168.5.5” of the IP packet may be inserted into the payload of the GTP-U packet of the UL-Data, and the packet information extracting unit 112a may extract the source IP address from the payload of the GTP-U packet of the UL-Data.

The abnormal packet detecting unit 122 may refer to the user equipment IP address corresponding to the extracted UL-TEID, e.g., “0xcd000004” from the tunnel information table, and detect the IP spoofing packet by comparing the source IP address with the user equipment IP address.

Referring again to FIG. 11, the MB Req message and the MB Resp message are transmitted to update the GTP tunnel between the S-GW 60 and the P-GW 70.

Referring to FIG. 12, as the GTP tunnel is updated, the updated UL-TEID, e.g., “0xcd000005” which is allocated to the GTP packet to be transmitted subsequently from the user equipment may be inserted into the payload of the MB Resp message. The packet information extracting unit 112a may extract the updated UL-TEID from the payload of the MB Resp message. In this case, the TEID being inserted into the header of the MB Resp message is the same as the F-TEID, e.g., “0xcd000001” being inserted into the payload of the CS Req message.

Referring again to FIG. 11, the GTP tunnel is updated, and the GTP-U packet is transmitted between the S-GW 60 and the P-GW 70.

Referring to FIG. 12, the UL-TEID, e.g., “0xcd000005” may be inserted into the header of the GTP-U packet of the UL-Data, and the packet information extracting unit 112a may extract the UL-TEID from the header of the GTP-U packet of the UL-Data. Further, the source IP address, e.g., “192.168.5.5” of the IP packet may be inserted into the payload of the GTP-U packet of the UL-Data, and the packet information extracting unit 112a may extract the source IP address from the payload of the GTP-U packet of the UL-Data.

The abnormal packet detecting unit 122 may refer to the user equipment IP address corresponding to the extracted UL-TEID, e.g., “0xcd000005” from the tunnel information table, and detect the IP spoofing packet by comparing the source IP address with the user equipment IP address.

Meanwhile, in the LTE network, the GTP-C packet may be transmitted between the MME 50 and the S-GW 60, and the GTP-U packet may be transmitted between the eNB 40 and the S-GW 60. The packet information extracting unit 112a may also extract the packet information or tunnel information from the GTP packet transmitted and received between the components of the network substantially in the same manner as that described with reference to FIGS. 11 and 12.

Since a detailed description of the data call setting and data transmission process in the LTE network might disturb the understanding of the main points of the present invention, the detailed description will be omitted.

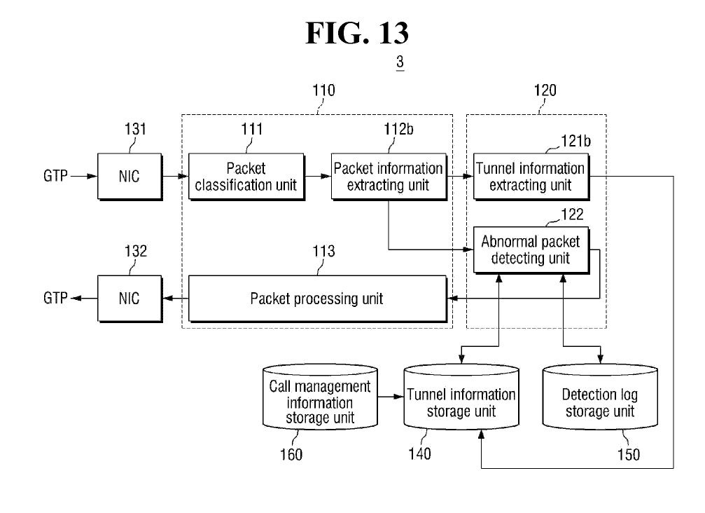

FIG. 13 is a schematic block diagram showing a configuration of an IP spoofing detection apparatus in accordance with still another embodiment of the present invention. For simplicity of description, the description will be made focusing on differences from the IP spoofing detection apparatus 2 of FIG. 8.

Referring to FIG. 13, an IP spoofing detection apparatus 3 in accordance with still another embodiment of the present invention includes the packet management module 110, the packet analyzing module 120, the tunnel information storage unit 140, the detection log storage unit 150, a call management information storage unit 160, and the NICs 131 and 132.

The packet management module 110 includes the packet classification unit 111, a packet information extracting unit 112b, and the packet processing unit 113.

The packet information extracting unit 112b extracts various kinds of packet information from the GTP packet according to the classification result of the packet classification unit 111.

In the case of the GTP-C packet, the packet information extracting unit 112b extracts the message type (Msg Type) and the TEID from the header of the GTP-C packet, and extracts the TEID which is allocated to the GTP packet to be transmitted subsequently, the MSISDN, and the IMSI from the payload of the GTP-C packet.

The packet analyzing module 120 includes a tunnel information extracting unit 121b, and the abnormal packet detecting unit 122.

The tunnel information extracting unit 121b extracts tunnel information based on the packet information of the GTP-C packet extracted by the packet information extracting unit 112b. The tunnel information includes the MSISDN of each GTP tunnel. The tunnel information may include the IMSI in addition to the MSISDN as the identification information of the user equipment. The tunnel information extracting unit 121b stores the extracted tunnel information in the tunnel information storage unit 140.

The call management information storage unit 160 records the user equipment IP address (UE IP) and the UL-TEID being transmitted while being inserted into the GTP-C packet when creating the GTP tunnel of the mobile network. The call management information storage unit 160 may record the updated UL-TEID being transmitted while being inserted into the GTP-C packet when updating the GTP tunnel. The UL-TEID and the user equipment IP address (UE IP) recorded in the call management information storage unit 160 are transmitted to the tunnel information storage unit 140.

The tunnel information storage unit 140 stores the tunnel information table in which the unique information of each GTP tunnel is recorded. The tunnel information table stores the UL-TEID, the user equipment IP address (UE IP), and the MSISDN for each GTP tunnel.

In the IP spoofing detection apparatus 3 of FIG. 13, although the call management information storage unit 160, the tunnel information storage unit 140 and the detection log storage unit 150 have been described as separate components, it is obvious to those skilled in the art that the call management information storage unit 160, the tunnel information storage unit 140 and the detection log storage unit 150 may be formed integrally with each other.

The IP spoofing detection apparatus 3 of FIG. 13 may be used to be disposed as an internal assembly of the GGSN 30 which transmits and receives the GTP packets in the WCDMA network. Further, the IP spoofing detection apparatus 3 of FIG. 13 may be used to be disposed as an internal assembly of the S-GW 60 and the P-GW 70 which transmits and receives the GTP packets in the LTE network. Further, the IP spoofing detection apparatus 3 of FIG. 13 may be used to be connected to each component of the mobile network.

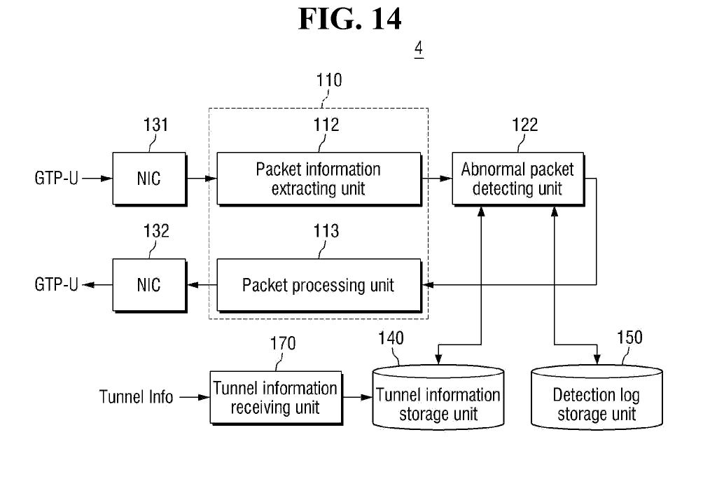

FIG. 14 is a schematic block diagram showing a configuration of an IP spoofing detection apparatus in accordance with still another embodiment of the present invention. For simplicity of description, the description will be made focusing on differences from the IP spoofing detection apparatus 1 of FIG. 5.

Referring to FIG. 14, an IP spoofing detection apparatus 4 in accordance with still another embodiment of the present invention includes the packet management module 110, the abnormal packet detecting unit 122, the tunnel information storage unit 140, the detection log storage unit 150, a tunnel information receiving unit 170, and the NICs 131 and 132.

The packet management module 110 includes the packet information extracting unit 112, and the packet processing unit 113.

The tunnel information receiving unit 170 receives the tunnel information of each GTP tunnel from the external device. The tunnel information includes the message type (Msg Type) and the TEID, which are extracted from the header of the GTP-C packet, and includes the TEID which is allocated to the GTP packet to be transmitted subsequently, the MSISDN, the IMSI, and the user equipment IP address, which are extracted from the payload of the GTP-C packet.

The tunnel information storage unit 140 stores the tunnel information table in which the unique information of each GTP tunnel is recorded. The tunnel information of each GTP tunnel transmitted from the tunnel information receiving unit 170 is stored in the tunnel information table.

The IP spoofing detection apparatus 4 of FIG. 14 may be used to be disposed on the S1-U interface between the eNB 40 and the S-GW 60 which transmit and receive the GTP-U packets in the LTE network. In this case, an external device which transmits the tunnel information of each GTP tunnel to the tunnel information receiving unit 170 may be disposed on the S11 interface between the MME 50 and the S-GW 60. The external device may include the packet classification unit 111, the packet information extracting unit 112a or 112b, the tunnel information extracting unit 121a or 121b and the like of the IP spoofing detection apparatus in accordance with some embodiments of the present invention.

The above-described IP spoofing detection apparatus in accordance with some embodiments of the present invention may be used in the WCDMA network or LTE network, but it is not limited thereto. It is obvious to those skilled in the art that the IP spoofing detection apparatus in accordance with some embodiments of the present invention may be used substantially in the same manner in various networks in which the GTP packets are used.

The steps and/or actions of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an application specific integrated circuit (ASIC). Additionally, the ASIC may reside in a user equipment. In the alternative, the processor and the storage medium may reside as discrete components in a user equipment.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. An IP spoofing detection apparatus comprising:
a tunnel information extracting unit which extracts a first TEID and a user equipment IP address from a payload of a first GTP packet; and
an abnormal packet detecting unit which extracts a second TEID from a header of a second GTP packet, and extracts a source IP address from a payload of the second GTP packet,
wherein the abnormal packet detecting unit detects the second GTP packet as an IP spoofing packet if the first TEID and the second TEID are equal to each other, and the user equipment IP address and the source IP address are different from each other.

2. The IP spoofing detection apparatus of claim 1, wherein the tunnel information extracting unit extracts a third TEID from a payload of a third GTP packet, and the abnormal packet detecting unit detects the second GTP packet as an IP spoofing packet if the third TEID and the second TEID are equal to each other, and the user equipment IP address and the source IP address are different from each other.

3. The IP spoofing detection apparatus of claim 1, further comprising a packet processing unit which drops the second GTP packet if the second GTP packet is detected as the IP spoofing packet.

4. The IP spoofing detection apparatus of claim 1, wherein the tunnel information extracting unit extracts at least one of a MSISDN and an IMSI from a payload of a fourth GTP packet, and a fourth TEID inserted into the payload of the fourth GTP packet is the same as a fifth TEID inserted into a header of the first GTP packet.

5. The IP spoofing detection apparatus of claim 4, further comprising a detection log storage unit which records at least one of the MSISDN and the IMSI if the second GTP packet is detected as the IP spoofing packet.

6. The IP spoofing detection apparatus of claim 5, wherein the detection log storage unit records at least one of detection time, presence or absence of blocking, the second TEID, destination IP address, destination port, source IP address, source port, and length of the packet if the second GTP packet is detected as the IP spoofing packet.

7. An IP spoofing detection apparatus comprising:
a call management information storage unit which records a first TEID and a user equipment IP address inserted into a payload of a first GTP packet; and
an abnormal packet detecting unit which extracts a second TEID from a header of a second GTP packet, and extracts a source IP address from a payload of the second GTP packet,
wherein the abnormal packet detecting unit detects the second GTP packet as an IP spoofing packet if the first TEID and the second TEID are equal to each other, and the user equipment IP address and the source IP address are different from each other.

8. The IP spoofing detection apparatus of claim 7, wherein the call management information storage unit records a third TEID inserted into a payload of a third GTP packet, and the abnormal packet detecting unit detects the second GTP packet as an IP spoofing packet if the third TEID and the second TEID are equal to each other, and the user equipment IP address and the source IP address are different from each other.

9. The IP spoofing detection apparatus of claim 7, further comprising a packet processing unit which drops the second GTP packet if the second GTP packet is detected as the IP spoofing packet.

10. The IP spoofing detection apparatus of claim 7, further comprising a tunnel information extracting unit which extracts at least one of a MSISDN and an IMSI from a payload of a fourth GTP packet, wherein a fourth TEID inserted into the payload of the fourth GTP packet is the same as a fifth TEID inserted into a header of the first GTP packet.

11. The IP spoofing detection apparatus of claim 10, further comprising a detection log storage unit which records at least one of the MSISDN and the IMSI if the second GTP packet is detected as the IP spoofing packet.

12. The IP spoofing detection apparatus of claim 11, wherein the detection log storage unit records at least one of detection time, presence or absence of blocking, the second TEID, destination IP address, destination port, source IP address, source port, and length of the packet if the second GTP packet is detected as the IP spoofing packet.

13. An IP spoofing detection apparatus comprising:
a tunnel information receiving unit which receives a first TEID and a user equipment IP address extracted from a payload of a first GTP packet; and
an abnormal packet detecting unit which extracts a second TEID from a header of a second GTP packet, and extracts a source IP address from a payload of the second GTP packet,
wherein the abnormal packet detecting unit detects the second GTP packet as an IP spoofing packet if the first TEID and the second TEID are equal to each other, and the user equipment IP address and the source IP address are different from each other.

14. The IP spoofing detection apparatus of claim 13, wherein the tunnel information receiving unit receives a third TEID extracted from a payload of a third GTP packet, and the abnormal packet detecting unit detects the second GTP packet as an IP spoofing packet if the third TEID and the second TEID are equal to each other, and the user equipment IP address and the source IP address are different from each other.

15. The IP spoofing detection apparatus of claim 13, further comprising a packet processing unit which drops the second GTP packet if the second GTP packet is detected as the IP spoofing packet.

16. The IP spoofing detection apparatus of claim 13, wherein the tunnel information receiving unit receives at least one of a MSISDN and an IMSI extracted from a payload of a fourth GTP packet, and a fourth TEID inserted into the payload of the fourth GTP packet is the same as a fifth TEID inserted into a header of the first GTP packet.

17. The IP spoofing detection apparatus of claim 16, further comprising a detection log storage unit which records at least one of the MSISDN and the IMSI if the second GTP packet is detected as the IP spoofing packet.

18. The IP spoofing detection apparatus of claim 17, wherein the detection log storage unit records at least one of detection time, presence or absence of blocking, the second TEID, destination IP address, destination port, source IP address, source port, and length of the packet if the second GTP packet is detected as the IP spoofing packet.

19. An IP spoofing detection apparatus comprising:
a packet information extracting unit which extracts a TEID from a header of a GTP packet and extracts a source IP address from a payload of the GTP packet; and
an abnormal packet detecting unit which refers to a user equipment IP address corresponding to the TEID from tunnel information stored in advance, and detects the GTP packet as an IP spoofing packet if the source IP address and the user equipment IP address are different from each other; and
a packet processing unit which drops the GTP packet if the GTP packet is detected as the IP spoofing packet.

20. The IP spoofing detection apparatus of claim 19, further comprising a detection log storage unit which records at least one of a MSISDN and an IMSI of a user equipment which transmits the GTP packet if the GTP packet is detected as the IP spoofing packet.
